(19) United States
(12) Patent Application Publication
(10) Pub. No.: US 2014/0189789 A1
(43) Pub. Date: Jul. 3, 2014

(54) METHOD AND APPARATUS FOR ENSURING COLLABORATION BETWEEN A NARROWBAND DEVICE AND A BROADBAND DEVICE

(71) Applicant: MOTOROLA SOLUTIONS, INC., Schaumburg, IL (US)

(72) Inventors: Adam C. Lewis, Buffalo Grove, IL (US); Alejandro G. Blanco, Fort Lauderdale, FL (US); Steven D. Upp, Bartlett, IL (US)

(73) Assignee: MOTOROLA SOLUTIONS, INC., Schaumburg, IL (US)

(21) Appl. No.: 13/728,711

(22) Filed: Dec. 27, 2012

(51) Int. Cl. H04L 29/06

(52) U.S. Cl. CPC H04L 63/08
USPC 726/3

(57) ABSTRACT

A network device is configured to authenticate a collaborative session between at least two communication devices. The network component receives an indication that at least two devices located within a predefined physical range are attempting to collaborate. The network component determines, based on the indication, that the two devices are authentic and that the two devices are attempting to collaborate. Responsive to determining that the two devices are authentic and attempting to collaborate, the network component determines that the two devices are authorized to collaborate and a level on which the two devices are authorized to collaborate. The network component sends an authorization response to at least one of the at least two devices, wherein if the two devices are authorized to collaborate the authorization response includes the level on which the two devices are authorized to collaborate.

### RELATED APPLICATIONS

The present application is related to the following United States Patent Applications commonly owned with this application by Motorola Solutions, Inc.: U.S. patent application Ser. No. 12/748,982, attorney docket number CM13189, filed Mar. 29, 2010, entitled “Methods for Authentication Using Near-Field”; U.S. patent application Ser. No. ______, attorney docket no. CM15507, entitled “Method of and System for Authenticating and Operating Personal Communication Devices over Public Safety Networks”; U.S. patent application Ser. No. ______, attorney docket no. CM15512, entitled “Method and Apparatus for Single Sign-On Collaboration Among Mobile Devices”; U.S. patent application Ser. No. ______, attorney docket no. CM15513, entitled “System For and Method Of Single Sign-On Collaboration Among Mobile Devices”; U.S. patent application Ser. No. ______, attorney docket no. CM15610, entitled “System and Method for Scoping a User Identity Assertion to Collaborative Devices”; and U.S. patent application Ser. No. ______, attorney docket no. CM15805, entitled “Apparatus For and Method of Multi-Factor Authentication Among Collaborating Mobile Devices”; which applications are commonly owned and filed on the same date as this application and the contents of which applications are incorporated herein in their entirety by reference thereto.

### FIELD OF THE DISCLOSURE

The present disclosure relates generally to authenticating, corroborating and authorizing collaboration requests made by two or more devices and determining levels of collaboration between the two or more devices.

### BACKGROUND

Narrowband or broadband networks include a number of infrastructure elements for facilitating communications between communication devices. For example, public safety organizations may use specialized voice communication systems embodied as narrowband radio systems that typically support low-bit-rate digital or analog transmission of audio and/or data streams. An example of such a narrowband network is a network used by a Project 25 (P25)-compatible two-way Push-To-Talk voice communication system that includes wireless and wired voice communication devices. Other examples include a Land Mobile Radio (LMR) system or a Terrestrial Trunked Radio (TETRA) system. The voice communication devices used in these narrowband systems may be, for example, portable narrowband two-way radios, mobile radios, dispatch consoles, or other similar voice communication entities that communicate with one another via wired and/or wireless networks. Public safety organizations may choose these narrowband systems because they provide improved end-to-end voice quality and efficient group communication, use advanced cryptography, enable centralized logging of calls, and/or are associated with lower delay and higher reliability.

In parallel, these organizations may also use broadband communication systems to access data applications. An example of such a broadband system is a wireless data network that operates in accordance with the Long Term Evolution (LTE) signaling standard. The communication devices used in broadband systems may be, for example, laptops, tablets, personal digital assistants (PDA), cellular telephones, or other similar communication entities that communicate with one another via wired and/or wireless networks. Broadband systems typically support high-bit-rate digital transmission of data streams, including real-time video. It is likely that a subscriber may possess both a narrowband device, for example, a portable narrowband two-way radio, and a broadband device, for example, a broadband-capable smart phone. This enables the subscriber, for example, to use the narrowband device to maintain voice communications using an existing narrowband P25 system, while being able to access data applications on the broadband device using a broadband connection.

In order to efficiently communicate on two or more devices, the two or more devices may be “paired” using, for example, Bluetooth technology. After two or more devices are paired, the devices may “collaborate”, i.e., the devices may be used to coordinate information sent from or received by the subscriber. The ability to perform device collaboration between a narrowband device and a broadband device being used by a single subscriber may enable the subscriber to use either the narrowband device or the broadband device beyond the capabilities offered by the narrowband system or the broadband system. For example, if the subscriber is a member of a talkgroup in the narrowband system, the subscriber may use the collaborating broadband device to receive discrete media from a collaborating broadband device of another participant of the talkgroup. The subscriber may also use the collaborating broadband device to send (push) discrete media to collaborating broadband device(s) of other participant(s) of the talkgroup. Collaboration between the narrowband device and the broadband device may also enable, for example, the ability to optimize location reporting, and the ability to route mission critical voice via the collaborating broadband device when the collaborating narrowband device is out of narrowband coverage.

Device collaboration or pairing using, for example, Bluetooth is performed in a peer-to-peer manner and is not authenticated by a network infrastructure component. Such peer-to-peer collaboration is vulnerable to attacks. For example, an imposter broadband device may obtain peer collaboration information from an unsuspecting narrowband device. The imposter broadband device can thereafter present itself to be collaborating with the narrowband device and obtain sensitive discrete media, report false location information on behalf of the narrowband device, or obtain mission critical voice flows destined to the narrowband device. Furthermore, different types of devices may perform different levels of collaboration. There is currently no avenue for authorizing different levels of collaboration between two or more devices.

Accordingly, there is a need for an apparatus and method for authenticating collaboration requests made by two or more devices and for determining levels of collaboration between the two or more devices.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a communication system used in accordance with some embodiments.

FIG. 2 is a flow diagram illustrating a method of collaboration in accordance with some embodiments.

FIG. 3 is a flow diagram illustrating a method of collaboration using near field in accordance with some embodiments.

FIG. 4 is another flow diagram illustrating a method of authentication in accordance with some embodiments.

FIG. 5 is another flow diagram illustrating a method of authentication in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Some embodiments are directed to methods and apparatuses for authenticating, corroborating, and authorizing a collaborative session between at least two communication devices. A network component receives an indication that at least two devices located within a predefined physical range are attempting to collaborate. The network component determines, based on the indication, that the at least two devices are authentic and that the at least two devices are attempting to collaborate. Responsive to determining that the least two devices are authentic and attempting to collaborate, the network component determines that the at least two devices are authorized to collaborate and a level on which the at least two devices are authorized to collaborate. The network component sends an authorization response to at least one of the at least two devices, wherein if the at least two devices are authorized to collaborate the authorization response includes the level on which the at least two devices are authorized to collaborate.

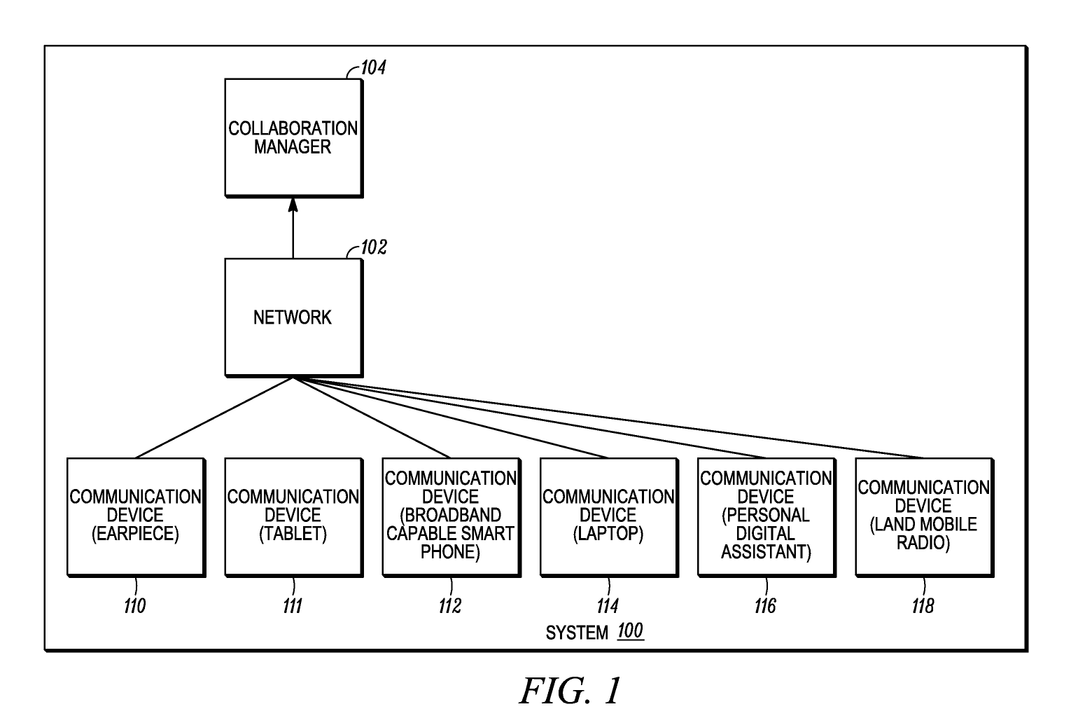

FIG. 1 is a block diagram of a communication system 100 used in accordance with some embodiments. Communication system 100 includes a number of communication devices, e.g., an earpiece 110, a tablet 111, a broadband capable smart phone 112, a laptop 114, a personal data assistant (PDA) 116, and a land mobile radio 118. Communication devices 110-118 can be any type of communication devices with wired, wireless and near-field capabilities. Each of communication devices 111, 112, 114, 116, or 118 is configured to operate on a narrowband network or a broadband network, shown generally to operate on network 102. Accordingly, network 102 may be any type of communication network, wherein the communication devices 110-118 communicate with infrastructure devices in the network using any suitable over-the-air protocol and modulation scheme.

Communication system 100 also includes collaboration manager 104 that implements methods and protocols consistent with the teachings herein for facilitating device collaboration. In one illustrative implementation, the collaboration manager 104 is a server, such as an authentication, authorization, and accounting server having memory, a processor, and a suitable wired and/or wireless interface operatively coupled for communicating with one or more of communication devices 111, 112, 114, 116, or 118. The collaboration manager 104 may include one or more components, wherein the functions of collaboration manager 104 described below may be performed in the one or more components (not shown) of collaboration manager 104. Other components of system 100 and network 102 are not shown for ease of illustration.

Two or more of the communication devices 110-118 may be operated by a user/subscriber. For example, the user may operate a land mobile radio (device 118) on a narrowband network to communicate with one or more other devices (not shown) on the narrowband network and, at the same time, the user may operate a broadband-capable smartphone (device 112), on a broadband network to communicate with one or more other devices (not shown) on the broadband network. Although device 118 and device 112 communicate with the system on different networks, these devices may be “paired” or “touched” to collaborate so that information sent to or received from one of device 112 or 118 may be based on information sent to or received from the other device 112 or 118. “Touching” the devices means that the devices are within range of the field of operation for a near-field signal to be communicated, i.e., the near-field signal is communicated between the devices from making physical contact with the devices or holding the devices up to about six inches apart.

Take the following example where device 118 is used in talkgroup communication over a narrowband network. Device 118 may communicate with other land mobile radios in the talkgroup via network 102. During the talkgroup session, device 112 may also send data to or receive data from other broadband devices in collaboration with other narrowband communication devices used in the talkgroup session. In such a case, before each of communication devices 112 and 118 is allowed to collaborate, each of communication devices 112 and 118 may authenticate with collaboration manager 104. In other words, each of communication devices 112 and 118 sends an indication, for example, a collaboration/registration request, to collaboration manager 104 for collaboration manager 104 to determine if communication devices 112 and 118 are authorized to collaborate. Responsive to authenticating with collaboration manager 104, collaboration manager 104 is configured to provide the level of collaboration allowed between communication devices 112 and 118 and collaboration manager 104 is configured to provide information that the collaboration is authorized by all parties involved, i.e., both communication devices 112 and 118 and collaboration manager 104.

In some embodiments, responsive to being authenticated by collaboration manager 104, each communication device being used to participate in a collaborative environment receives an indication that the communication device is authorized to collaborate with another communication device in the collaborative environment. For example, if devices 112 and 118 are to collaborate, each of devices 112 and 118 sends a collaboration session identifier to the other of devices 112 and 118 during the pairing process. Thereafter, each of devices 112 and 118 sends a collaboration request message to collaboration manager 104, wherein each collaboration request message includes the collaboration session identifier sent by the requestor and the collaboration session identifier received by the requestor. Responsive to collaboration manager 104 receiving the collaboration request messages from each of devices 112 and 118, collaboration manager 104 is configured to use predefined rules/policies to determine if devices 112 and 118 are authorized to collaborate and on what level. For example, collaboration manager 104 may ensure that devices 112 and 118 are allowed to collaborate by comparing the received session identifiers in each collaboration request, and if there is a match, collaboration manager 104 may approve the collaboration request. Collaboration manager 104 then returns a collaboration response message to each device, wherein the response message indicates that devices 112 and 118 are allowed to collaborate and includes the manner in which devices 112 and 118 are authorized to collaborate. For example, collaboration manager 104 may indicate to devices 112 and 118 that they may participate in full collaboration, device pass-through collaboration, application-level collaboration, device remote user interface collaboration, infrastructure collaboration, or no collaborating. Accordingly, the response message is used to notify each communication device of the level collaboration that is allowed.

In some embodiments, the session identifier may used by each device 112 and 118 to authenticate devices 112 and 118 and to “prove” to the network entity that devices 112 and 118 are mutually attempting to collaborate with each other. Proving to the network entity that devices 112 and 118 are attempting to collaborate does not authorize them to collaborate. When the network entity determines that authentic devices are attempting to collaborate, the network entity may further use rules, stored by the network entity or another component or dynamically generated rules accessed by the network entity, to determine if devices 112 and 118 are authorized to collaborate. If devices 112 and 118 are authorized to collaborate, the network component may then determine the level on which the devices are authorized to collaborate. Accordingly, for each collaboration request received by the network entity, the network entity performs authentication, corroboration, and authorization. For example, when each device 112 and 118 sends its collaboration request message to collaboration manager 104, collaboration manager 104 authenticates each device 112 and 118, and once each device is authenticated, collaboration manager 104 corroborates that device 112 wants to collaborate with device 118, and vice versa. Then, collaboration manager 104 uses out of band information to determine at what level device 112 and 118 are allowed to collaborate and collaboration manager 104 sends that back to each device 112 and 118 via a collaboration response message.

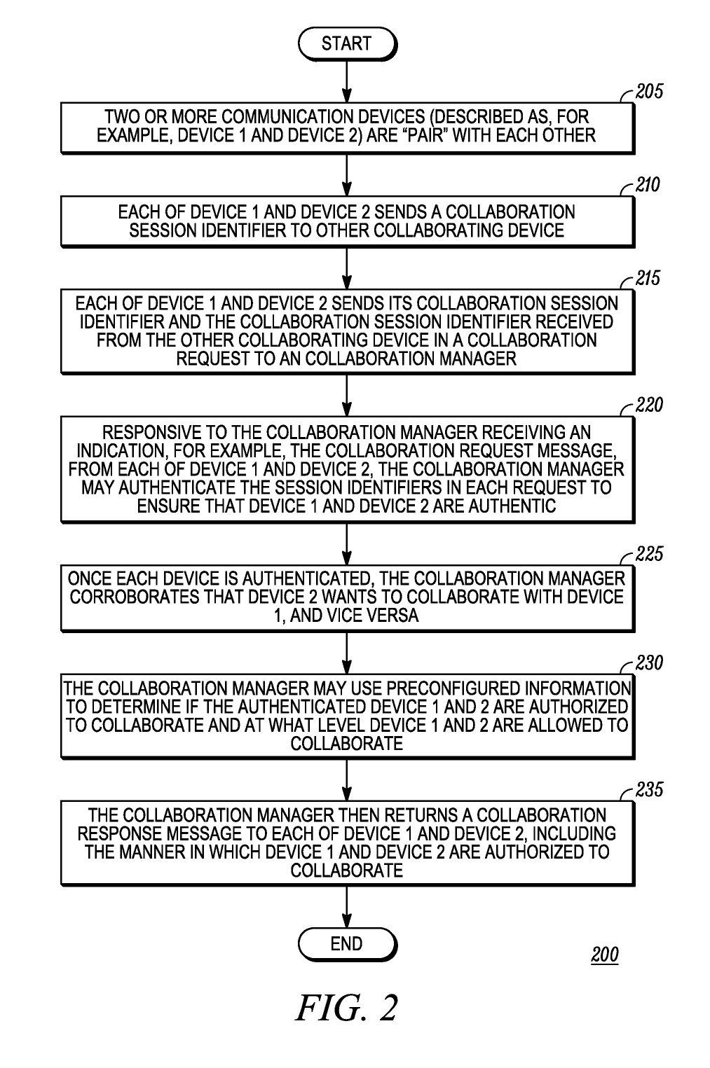

FIG. 2 is a flow diagram illustrating a method 200 of collaboration in accordance with some embodiments. At 205, two or more communication devices (described as, for example, device 1 and device 2) are “paired” with each other. At 210, each of device 1 and device 2 sends a collaboration session identifier to the other collaborating device. For example, device 1 sends its collaboration session identifier to device 2 and device 2 sends its collaboration session identifier to device 1. At 215, each of device 1 and device 2 sends its collaboration session identifier and the collaboration session identifier received from the other collaborating device in a collaboration request to a collaboration manager. For example, device 1 may send its collaboration session identifier and the collaboration session identifier received from collaborating device 2 in a collaboration request to the collaboration manager. Accordingly, in some embodiments, for a given number of collaboration request messages received by the collaboration manager, the collaboration manager may expect to receive that number of collaborative session identifiers. At 220, responsive to the collaboration manager receiving an indication, for example, the collaboration request message, from each of device 1 and device 2, the collaboration manager may authenticate the session identifiers in each request to ensure that device 1 and device 2 are authentic and that device 1 and device 2 are attempting to collaborate. For example, the collaboration manager may use the session identifier for each device to authenticate each device 1 and 2. At 225, once each device is authenticated, the collaboration manager corroborates that device 2 wants to collaborate with device 1, and vice versa. The collaboration manager may ensure that device 1 and device 2 are allowed to collaborate by comparing the received collaborative session identifiers and determining that the collaborative session identifiers match. At 230, the collaboration manager may use preconfigured information to determine if the authenticated device 1 and 2 are authorized to collaborate and at what level device 1 and 2 are allowed to collaborate. At 225, the collaboration manager then returns a collaboration response message to each of device 1 and device 2, including the manner in which device 1 and device 2 are authorized to collaborate.

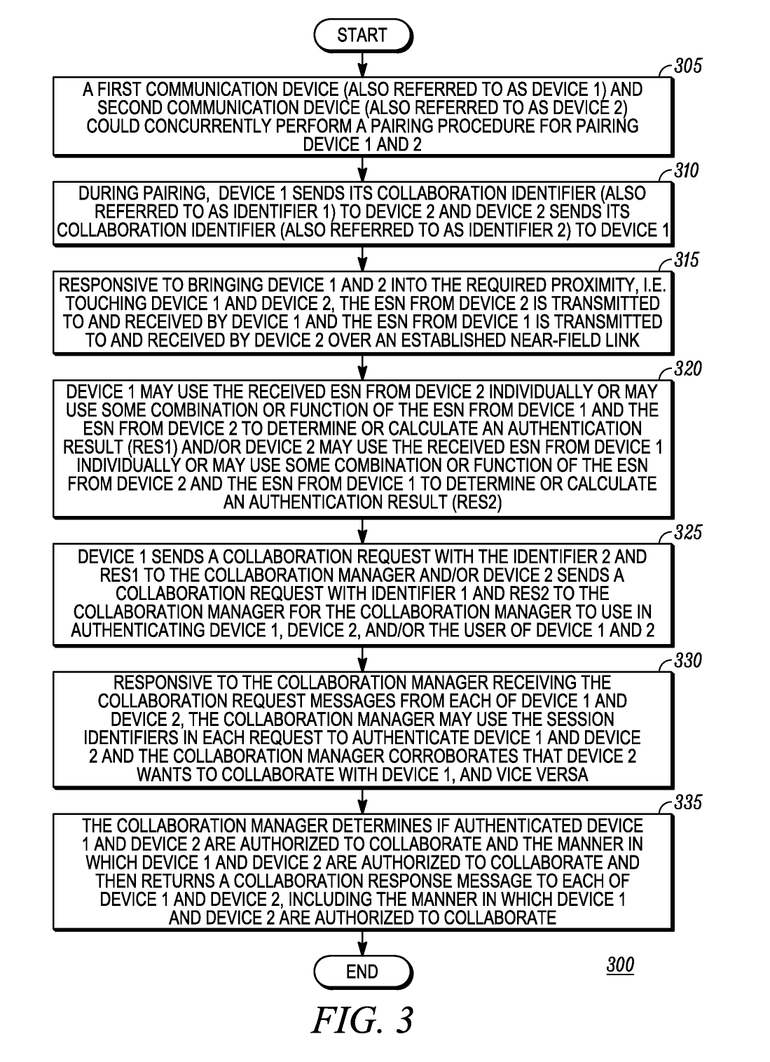

FIG. 3 is a flow diagram illustrating a method 300 of collaboration using near field in accordance with some embodiments. At 305, for example, a first communication device (also referred to as device 1) and second communication device (also referred to as device 2) could concurrently perform a pairing procedure for pairing device 1 and 2. At 310, during pairing, device 1 sends its collaboration identifier (also referred to as identifier 1) to device 2 and device 2 sends its collaboration identifier (also referred to as identifier 2) to device 1. Identifier 1 may include an electronic serial number (ESN) for device 1 and identifier 2 may include an ESN for device 2, wherein each ESN is a unique identification number embedded or inscribed on a microchip in the device. At 315, responsive to bringing device 1 and 2 into the required proximity, i.e. touching device 1 and device 2, the ESN from device 2 is transmitted to and received by device 1 and the ESN from device 1 is transmitted to and received by device 2 in a non-propagating near-field signal over an established near-field link.

At 320, device 1 may use the received ESN from device 2 individually or may use some combination or function of the ESN from device 1 and the ESN from device 2 to determine or calculate an authentication result (RES1) and/or device 2 may use the received ESN from device 1 individually or may use some combination or function of the ESN from device 2 and the ESN from device 1 to determine or calculate an authentication result (RES2). At 325, device 1 sends a collaboration request with the identifier 2 and RES1 to the collaboration manager and/or device 2 sends a collaboration request with identifier 1 and RES2 to the collaboration manager for the collaboration manager to use in authenticating device 1, device 2, and/or the user of device 1 and 2. At 330, responsive to the collaboration manager receiving the collaboration request messages from each of device 1 and device 2, the collaboration manager may use the session identifiers in each request to authenticate device 1 and device 2 and the collaboration manager corroborates that device 2 wants to collaborate with device 1, and vice versa. At 335, the collaboration manager determines if authenticated device 1 and device 2 are authorized to collaborate and the manner in which device 1 and device 2 are authorized to collaborate and then returns a collaboration response message to each of device 1 and device 2, including the manner in which device 1 and device 2 are authorized to collaborate.

In some embodiments, device 1 may generate an authentication key by applying a function to at least a portion of ESN1 and ESN2 and a secret key stored in device 1 and derive the RES1 using the authentication key. Device 2 may also generate an authentication key by applying a function to at least a portion of ESN1 and ESN2 and a secret key stored in device 2 and derive the RES2 using the authentication key. The complexity of the function used to generate RES1 and/or RES2 depends on the level of security desired in the system and could involve a mathematical equation or algorithm or a concatenation of one or both of the ESN1 and ESN2. For example, device 1 and device 2 may each include a random number generator, which generates a random number (RAND1) and a random number (RAND2). Device 1 may calculate RES1 as a function of ESN1, ESN2, and RAND1 and device 2 may calculate RES2 as a function of ESN1, ESN2, and RAND2. Device 1 may send RAND1 and RES1 to the collaboration manager and device 2 may send RAND2 and RES2 to the collaboration manager.

The collaboration manager may independently determine its own authentication result, which it compares to RES1 and/or RES2 to confirm the RES1 and/or RES2. For example, to confirm RES1, the collaboration manager may self-generate an authentication result by performing a function on RAND1 (sent by the device1) and ESN1 and ESN2 (ESN1 and ESN2 may already provisioned in the collaboration manager for use in authentication). If the two authentication results match, the collaboration manager may successfully authenticate device 1, which means that device1 and the collaboration manager performed the same function on the same two ESNs. The collaboration manager could perform the same function on RAND2 and ESN1 and ESN2. Otherwise, if the two authentication results fail to match, the collaboration manager may deny authentication of device 1. The collaboration manager, upon determining a authentication status (successful or failed), completes the authentication process by sending an authentication response to the device 1 and/or device 2, which indicates the authentication status of the device1, device2, and/or user of the devices, including the manner in which device 1 and device 2 are authorized to collaborate.

In some embodiments, device 1 may send RES1 and/or device 2 may send RES2 in response to an authentication demand from the collaboration manager. In some cases, the collaboration manager may send the authentication demand subsequent to device 1 and/or device 2 sending collaboration requests, thus the demand is initiated by the device(s) requesting to collaborate on the network. In other cases, the authentication demand may be initiated by collaboration manager. For example, once authentication is successful, the collaboration manager might periodically challenge the authentication. This ensures, for example, that an operational radio has not been stolen or that the operational radio is not being used in collaboration with a different accessory. In this example, unless both stolen both collaborating devices are stolen, the subsequent authentication will fail.

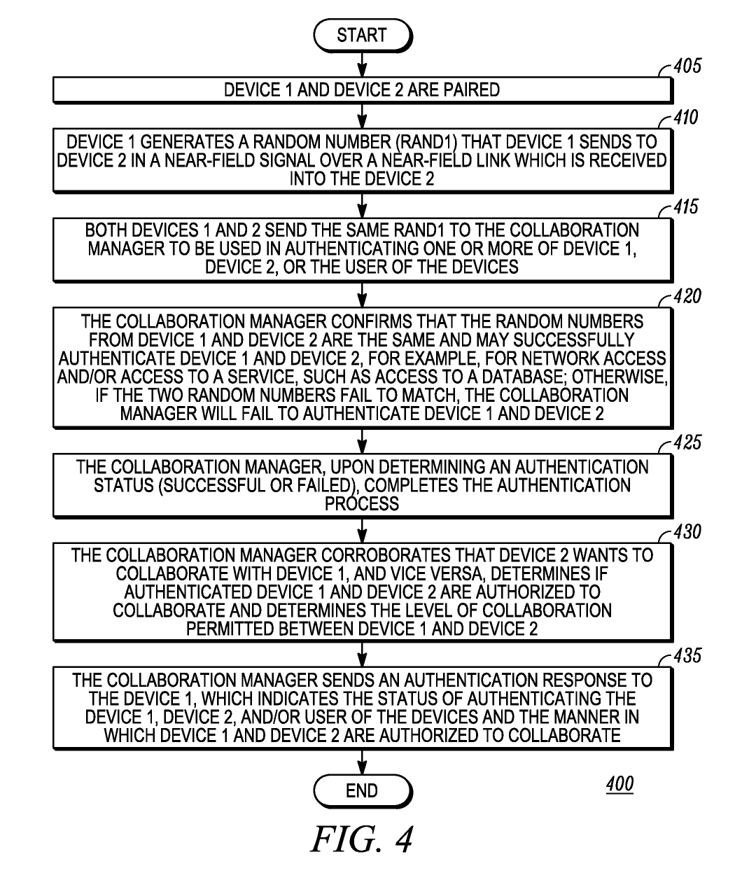

FIG. 4 is another flow diagram illustrating a method 400 of authentication in accordance with some embodiments. At 405, device 1 and device 2 are paired. At 410, device 1 generates a random number (RAND1) that device 1 sends to device 2 in a near-field signal over a near-field link which is received into the device 2. At 415, both devices 1 and 2 send the same RAND1 to the collaboration manager to be used in authenticating one or more of device 1, device 2, or the user of the devices. For example, device 1 may generate and send the RAND1 in response to an authentication demand from the collaboration manager. At 420, the collaboration manager confirms that the random numbers from device 1 and device 2 are the same and may successfully authenticate device 1 and device 2, for example, for network access and/or access to a service, such as access to a database. Otherwise, if the two random numbers fail to match, the collaboration manager will fail to authenticate device 1 and device 2. At 425, the collaboration manager, upon determining an authentication status (successful or failed), completes the authentication process. At 430, the collaboration manager corroborates that device 2 wants to collaborate with device 1, and vice versa, determines if authenticated device 1 and device 2 are authorized to collaborate and determines the level of collaboration permitted between device 1 and device 2. At 435, the collaboration manager sends an authentication response to the device 1, which indicates the status of authenticating the device 1, device 2, and/or user of the devices and the manner in which device 1 and device 2 are authorized to collaborate.

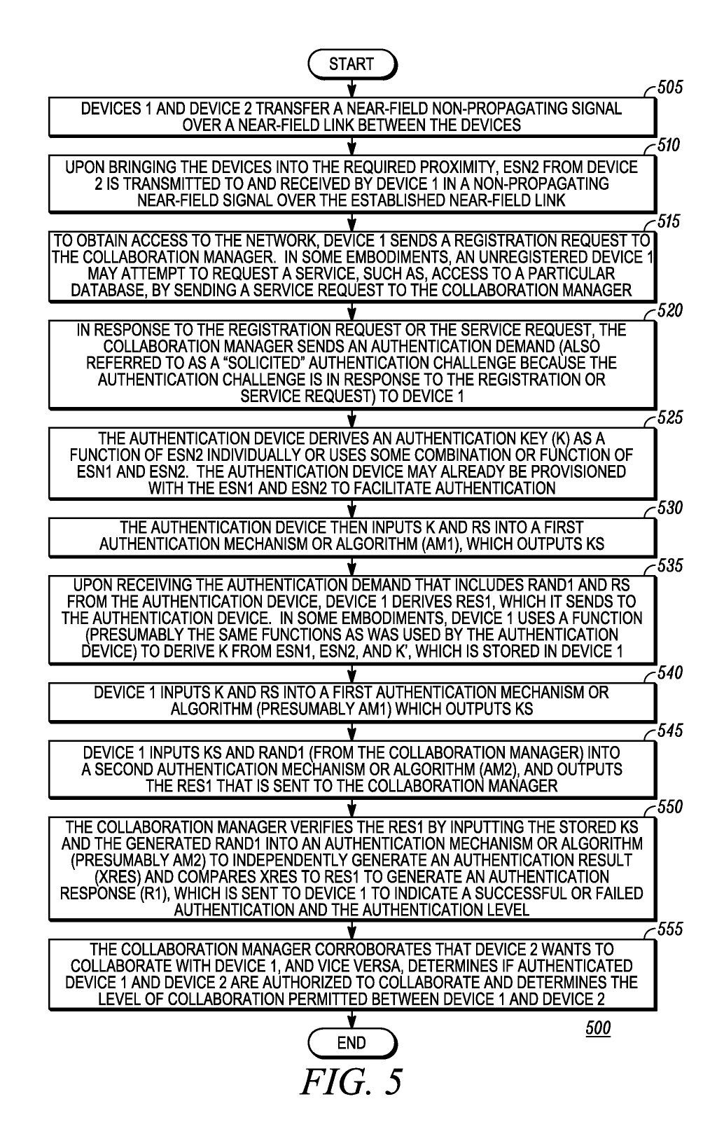

FIG. 5 is another flow diagram illustrating a method 500 of authentication in accordance with some embodiments. At 505, devices 1 and device 2 transfer a near-field non-propagating signal over a near-field link between the devices. At 510, upon bringing the devices into the required proximity, ESN2 from device 2 is transmitted to and received by device 1 in a non-propagating near-field signal over the established near-field link. At 515, to obtain access to the network, for example network 102, device 1 sends a registration request to the collaboration manager. In some embodiments, an unregistered device 1 may attempt to request a service, such as, access to a particular database, by sending a service request to the collaboration manager. At 520, in response to the registration request or the service request, the collaboration manager sends an authentication demand (also referred to as a “solicited” authentication challenge because the authentication challenge is in response to the registration or service request) to device 1. In a further implementation, at any time after a successful authentication of the device 1, the collaboration manager can send an “unsolicited” authentication challenge, which is not in response to the registration request from the device 1. In an embodiment, the authentication demand may include a random challenge (RAND1) and a random seed (RS) generated by the collaboration manager using a random number generator. The collaboration manager further generates a session authentication key (KS). The session RS and KS make up session authentication information (SAI) that is used for a predefined period of time in performing real-time authentication of the device 1, wherein “real-time” is meant with negligible delay.

At 525, the collaboration manager derives an authentication key (K) as a function of ESN2 individually or uses some combination or function of ESN1 and ESN2. The collaboration manager may already be provisioned with the ESN1 and ESN2 to facilitate authentication. At 530, the collaboration manager then inputs K and RS into a first authentication mechanism or algorithm (AM1), which outputs KS.

At 535, upon receiving the authentication demand that includes RAND1 and RS from the collaboration manager, device 1 derives RES1, which it sends to the collaboration manager. In some embodiments, device 1 uses a function (presumably the same functions as was used by the collaboration manager) to derive K from ESN1, ESN2, and K′, which is stored in device 1. At 540, device 1 inputs K and RS into a first authentication mechanism or algorithm (presumably AM1), which outputs KS. At 545, device 1 inputs KS and RAND1 (from the collaboration manager) into a second authentication mechanism or algorithm (AM2), and outputs the RES1 that is sent to the collaboration manager.

At 550, the collaboration manager verifies the RES1 by inputting the stored KS and the generated RAND1 into an authentication mechanism or algorithm (presumably AM2) to independently generate an authentication result (XRES) and compares XRES to RES1 to generate an authentication response (R1), which is sent to device 1 to indicate a successful or failed authentication and the authentication level. When the authentication functions (e.g., AM1 and AM2) and the ESN1 and ESN2 used in the device 1 and the collaboration manager are the same, then the RES1 and XRES will be the same, producing a positive R1 indicating successful authentication of the device 1 (and/or the device 2) to the network and/or the user for a service. At 555, the collaboration manager corroborates that device 2 wants to collaborate with device 1, and vice versa, determines if authenticated device 1 and device 2 are authorized to collaborate, and determines the level of collaboration permitted between device 1 and device 2. Otherwise, if any of the authentication functions and ESN1 and ESN2 is different, this indicates an unauthorized device and/or user and R1 will be a negative response indicating failed authentication.

As mentioned above, even if R1 is positive, the collaboration manager may periodically initiate an unsolicited authentication demand to challenge authentication. In such a case, method 500 will be repeated. Instead of receiving the ESN from device 2 each time an authentication demand is received, in an embodiment, the device 1 stores the last ESN that it receives over the near-filed link and uses that ESN to perform the authentication method in accordance with the present teachings. If during a subsequent authentication procedure, the device1 still has stored therein the ESN2, the RES1 that it generates and sends to the collaboration manager will again match with XRES1, and R1 will indicate a successful authentication.

However, suppose that in the interim, a different device (device 3) has paired with device1 and has an ESN that is other than ESN2 (i.e., ESN3). When device 1 touches device 3, ESN3 will be transferred to and stored in device 1 to be use for subsequent authentication; thus, device 1 may clear ESN2 from its memory and replace it with ESN3. Accordingly, when the device 1 derives the authentication response as a function of the ESN1 and the stored ESN (in this case the ESN3), the authentication result will not match the authentication result independently generated in the collaboration manager, and the authentication response from the collaboration manager will, therefore, indicate a failed authentication since the ESN is not ESN2, which is provisioned in the collaboration manager.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. For example, collaboration manager 104 and communication devices 110-118 of FIG. 1 may comprise a set of instructions (perhaps stored in a volatile or non-volatile computer readable medium) that, when executed by a processor, perform some or all of the steps set forth in FIGS. 2-5 and corresponding text. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
receiving, on a network component, an indication that at least two devices located within a predefined physical range are attempting to collaborate;
determining, on the network component based on the indication, that the at least two devices are authentic and that the at least two devices are attempting to collaborate;
responsive to determining that the at least two devices are authentic and attempting to collaborate, determining that the at least two devices are authorized to collaborate and a level on which the at least two devices are authorized to collaborate; and
sending, by the network component, an authorization response to at least one of the at least two devices, wherein if the at least two devices are authorized to collaborate the authorization response includes the level on which the at least two devices are authorized to collaborate.

2. The method of claim 1, wherein the indication is a collaboration request message received from each of the at least two devices, wherein the collaboration request message includes a session identifier for each of the at least two devices exchanged during a pairing operation.

3. The method of claim 2, wherein the determining comprises determining that the at least two devices are authentic and authorized to collaborate and the level on which the at least two devices are authorized to collaborate based on information received in the collaboration request message from each of the at least two devices.

4. The method of claim 2, wherein the determining comprises determining that the at least two devices are authentic and are attempting to collaborate by comparing the session identifiers in the collaboration request messages, wherein if the session identifiers in the collaboration request messages match the at least two devices are determined to be attempting to collaborate.

5. The method of claim 1, wherein the level on which the at least two devices are authorized to collaborate comprises at least one of full collaboration, device pass-through collaboration, application-level collaboration, device remote user interface collaboration, infrastructure collaboration, or no collaboration.

6. The method of claim 1, wherein the indication is a collaboration request message received from at least one of the at least two devices, wherein the collaboration request message includes at least one of a serial number for one of the at least two devices received by another of the at least two devices during a pairing operation and includes an authentication result calculated from the serial number or from a function of at least one of serial numbers from each of the at least two devices, a secret key, and a random number.

7. The method of claim 6, wherein the determining comprises determining that the at least two devices are authentic and are attempting to collaborate by generating a network authentication result and comparing the network authentication result to the authentication result received in the collaboration request message,
wherein if the network authentication result match the authentication result received in the collaboration request message, the at least two devices are determined to be authenticate and are determined to be attempting to collaborate.

8. The method of claim 1, further comprising periodically sending, by the network component, an authentication demand to at least one of the at least two devices.

9. The method of claim 1, the receiving comprises receiving a collaboration request message from the at least two devices, wherein the collaboration request messages includes a random number generated by one of at least two devices and received by another of the at least two devices during a pairing operation.

10. The method of claim 9, wherein the determining comprises determining that the at least two devices are authentic and are attempting to collaborate by comparing the random numbers received in the collaboration request messages,
wherein if the random numbers match, the at least two devices are determined to be authenticate and are determined to be attempting to collaborate.

11. The method of claim 1, the receiving comprises:
receiving a collaboration request message from at least one of the at least two devices, wherein the collaboration request message includes at least one of a serial number for one of the at least two devices received by another of the at least two devices during a pairing operation;
sending an authentication demand to the at least one of the at least two devices that sent the collaboration request message, wherein the demand comprises a random challenge and a random seed generated by the network component;
generating an authentication key and inputting the collaboration request message and the random seed into a first authentication mechanism to generate an authentication session key, a random challenge and a random seed; and
receiving an authentication result derived by the at least one of the at least two devices that sent the collaboration request message from at least one of the random challenge and the random seed.

12. The method of claim 11, wherein the determining comprises determining that the at least two devices are authentic and are attempting to collaborate by verifying the authentication result derived by the at least one of the at least two devices that sent the collaboration request message and generating an authentication response
wherein if the authentication response is positive, the at least two devices are determined to be authenticate and are determined to be attempting to collaborate.

13. A apparatus comprising:
a processor configured to:
receive an indication that at least two devices located within a predefined physical range are attempting to collaborate;
determine, based on the indication, that the at least two devices are authentic and that the at least two devices are attempting to collaborate;
responsive to determining that the at least two devices are authentic and attempting to collaborate, determine that the at least two devices are authorized to collaborate and a level on which the at least two devices are authorized to collaborate; and
transmit an authorization response to at least one of the at least two devices, wherein if the at least two devices are authorized to collaborate the authorization response includes the level on which the at least two devices are authorized to collaborate.

14. The apparatus of claim 13, wherein the apparatus is configured to receive a collaboration request message from each of the at least two devices, wherein the collaboration request message includes a session identifier for each of the at least two devices exchanged during a pairing operation.

15. The apparatus of claim 14, wherein the apparatus is configured to determine that the at least two devices are authentic and are attempting to collaborate by comparing the session identifiers in the collaboration request messages, wherein if the session identifiers in the collaboration request messages match the at least two devices are determined to be authentic and are determined to be attempting to collaborate.

16. The apparatus of claim 13, wherein the level on which the at least two devices are authorized to collaborate comprises at least one of full collaboration, device pass-through collaboration, application-level collaboration, device remote user interface collaboration, infrastructure collaboration, or no collaboration.

17. The apparatus of claim 13, wherein the apparatus is configured to receive a collaboration request message from at least one of the at least two devices, wherein the collaboration request message includes at least one of a serial number for one of the at least two devices received by another of the at least two devices during a pairing operation and includes an authentication result calculated from the serial number or from a function of at least one of serial numbers from each of the at least two devices, a secret key, and a random number; and
wherein the apparatus is configured to determine that the at least two devices are authentic and are attempting to collaborate by generating a network authentication result and comparing the network authentication result to the authentication result received in the collaboration request message,
wherein if the network authentication result match the authentication result received in the collaboration request message, the at least two devices are determined to be authentic and are determined to be attempting to collaborate.

18. The apparatus of claim 13, wherein the apparatus is configured to receive a collaboration request message from the at least two devices, wherein the collaboration request messages includes a random number generated by one of at least two devices and received by another of the at least two devices during a pairing operation; and
wherein the apparatus is configured to determine that the at least two devices are authentic and are attempting to collaborate by comparing the random numbers received in the collaboration request messages,
wherein if the random numbers match, the at least two devices are determined to be authentic and are determined to be attempting to collaborate.

19. The apparatus of claim 13, wherein the apparatus is configured to:
receive a collaboration request message from at least one of the at least two devices, wherein the collaboration request message includes at least one of a serial number for one of the at least two devices received by another of the at least two devices during a pairing operation;
send an authentication demand to the at least one of the at least two devices that sent the collaboration request message, wherein the demand comprises a random challenge and a random seed generated by the apparatus;
generate an authentication key and input the collaboration request message and the random seed into a first authentication mechanism to generate an authentication session key, a random challenge and a random seed;
receive an authentication result derived, by the at least one of the at least two devices that sent the collaboration request message, from at least one of the random challenge and the random seed; and
determine that the at least two devices are authentic and are attempting to collaborate by verifying the authentication result derived by the at least one of the at least two devices that sent the collaboration request message and generating an authentication response, wherein if the authentication response is positive, the at least two devices are determined to be authentic and are determined to be attempting to collaborate.

20. The apparatus of claim 13, further configured to periodically send an authentication demand to at least one of the at least two devices.
